(19) United States
(12) Patent Application Publication
(10) Pub. No.: US 2016/0094947 A1
(43) Pub. Date: Mar. 31, 2016

(54) Bluetooth-Based Positioning Method and Apparatus

(71) Applicant: Alibaba Group Holding Limited, Grand Cayman (KY)

(72) Inventors: Hui Shen, Hangzhou (CN); Yunjiao Yao, Hangzhou (CN); Xiao Qian, Hangzhou (CN); Zhipeng Zhang, Hangzhou (CN); Hanbo Ma, Hangzhou (CN)

(21) Appl. No.: 14/863,226

(22) Filed: Sep. 23, 2015

(30) Foreign Application Priority Data
Sep. 25, 2014 (CN) 201410499727.9

(51) Int. Cl. H04W 4/02; H04W 8/26; H04W 4/00; H04W 8/00

(52) U.S. Cl. CPC H04W 4/023; H04W 8/005; H04W 8/26; H04W 4/008

(57) ABSTRACT

A Bluetooth-based positioning method and an apparatus thereof are disclosed. The method includes a mobile terminal receiving a Bluetooth signal transmitted by at least one Bluetooth beacon device; obtaining a media access control (MAC) address of each Bluetooth beacon device according to the received Bluetooth signal, and selecting Bluetooth beacon devices having a respective MAC address as a first MAC address to be reference devices; obtaining a Bluetooth signal strength and a broadcast beacon identifier of each reference device; and calculating a position of the mobile terminal according to the obtained Bluetooth signal strength and the obtained broadcast beacon identifier of each reference device. The method sets all the Bluetooth beacon devices to have a same MAC address, and MAC addresses of other normal Bluetooth devices are different from the MAC address of these Bluetooth beacon devices, thus effectively eliminating an interference from the other Bluetooth devices and preventing a malicious Bluetooth device from disguising a same beacon identifier to implement an accurate positioning.

### CROSS REFERENCE TO RELATED PATENT APPLICATION

This application claims foreign priority to Chinese Patent Application No. 201410499727.9 filed on Sep. 25, 2014, entitled “Bluetooth-Based Positioning Method and Apparatus”, which is hereby incorporated by reference in its entirety.

### TECHNICAL FIELD

The present disclosure relates to the field of communications, and more particularly to a Bluetooth-based positioning technology.

### BACKGROUND

The rapid development and popularization of mobile terminals, such as mobile phones and handheld computers, has caused the emergence and rapid development of indoor (or local) positioning technologies, in which a variety of technologies such as wireless communications, base station positioning and inertial navigation system positioning, etc., are mainly integrated to form a set of indoor positioning systems for monitoring locations of people and objects in an indoor space. Widespread needs and applications thereof are found in many fields such as commercial applications, public safety and military scenarios.

Existing indoor positioning technologies mainly use devices capable of generating electromagnetic signals, such as Bluetooth devices, wireless access devices and geomagnetic devices, etc., as reference devices. Indoor positioning technologies based on Bluetooth devices mainly arrange a number of Bluetooth signal transmission apparatuses in a space where positioning is needed in advance, and then perform positioning according to a Bluetooth signal at a current position received by a mobile terminal. Since a number of devices having a function of transmitting Bluetooth signals, e.g., a mobile phone, exist, a signal field formed by this type of Bluetooth signal transmission device is prone to interference. Moreover, if someone disguises a reference device, an error may occur in matching of positioning, thus affecting the accuracy of positioning.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

An objective of the present disclosure is to provide a Bluetooth-based positioning method and an apparatus thereof, which are able to effectively eliminate an interference from other Bluetooth devices, and prevent a malicious Bluetooth device from disguising to have a same beacon identifier, thereby achieving an accurate positioning.

In order to solve the foregoing technical problems, embodiments of the present disclosure disclose a Bluetooth-based positioning method, in which at least two Bluetooth beacon devices are arranged in advance in an area where positioning is desired, media access control (MAC) addresses of the Bluetooth beacon devices are set to be a first MAC address in advance, and the Bluetooth beacon devices broadcast different beacon identifiers.

In an implementation, the method may include a mobile terminal receiving a Bluetooth signal that is transmitted by at least one Bluetooth beacon device; obtaining a MAC address of each Bluetooth beacon device based on the received Bluetooth signal and selecting Bluetooth beacon device(s) having respective MAC address(es) as the first MAC address to be reference device(s); obtaining Bluetooth signal strength and a broadcast beacon identifier of each reference device based on the received Bluetooth signal; and computing a position of the mobile terminal based on the obtained Bluetooth signal strength and the obtained broadcast beacon identifier of each reference device.

The embodiments of the present disclosure further disclose a Bluetooth-based positioning apparatus, in which at least two Bluetooth beacon devices are arranged in advance in an area where positioning is desired, MAC addresses of the Bluetooth beacon devices are preset to be a first MAC address, and the Bluetooth beacon devices broadcast different beacon identifiers.

In an implementation, the apparatus may include a receiving unit to control a mobile terminal to receive a Bluetooth signal that is transmitted by at least one Bluetooth beacon device; a selection unit to obtain a MAC address of each Bluetooth beacon device based on the received Bluetooth signal and to select Bluetooth beacon device(s) having respective MAC address(es) as the first MAC address to be reference devices; an acquisition unit to obtain a Bluetooth signal strength and a broadcast beacon identifier of each reference device based on the received Bluetooth signal; and a computation unit to compute a position of the mobile terminal based on the obtained Bluetooth signal strength and the obtained broadcast beacon identifier of each reference device.

As compared with existing technologies, main differences and efforts of the embodiments of the present disclosure therefrom include the following.

As commonly known in existing technologies, each wireless device should have a different MAC address. The present disclosure, however, creatively sets all Bluetooth beacon devices to have a same MAC address. According to the international Bluetooth standard, these Bluetooth beacon devices are regarded as the same device, and MAC addresses of other normal Bluetooth devices are different from the MAC address of these Bluetooth beacon devices. Therefore, interference from other Bluetooth devices can be effectively eliminated through recognizing the MAC address, thus achieving an accurate positioning.

Furthermore, time-varying encryption and decryption is performed on a Bluetooth signal, which can effectively prevent a malicious Bluetooth device from disguising the same beacon identifier, and thus achieve an accurate positioning.

Moreover, random moving step sizes are assigned to particles at an initial stage of positioning. Thereafter, moving step sizes of particles having low usability scores are abandoned, and moving step sizes of particles having high usability scores are retained during the positioning. As such, moving step sizes that are closest to an actual step size of a positioned object can be obtained during the positioning and can be updated timely as the step size of the positioned object changes.

Furthermore, an aggregation degree of scores of particles in a current particle set is calculated. If the particle score aggregation degree is low, this indicates that the positioning fails. A re-initialization for generating an initial particle set needs to be performed, moving step sizes are updated, and the mobile terminal is located to avoid unnecessary computation and improve positioning efficiency.

Furthermore, a rasterization search is performed so that a comparison of each particle with all signal fingerprints in a fingerprint map is not needed, thus greatly reducing computation workload and improving positioning efficiency.

Moreover, when the score aggregation degree of the particles in the current particle set is low while a failure in positioning is not resulted yet, the current particle set may be updated. Particles having a low score may be deleted, and new particles may be generated based on particles having a high score to improve a score aggregation degree of the entire current particle set, thereby improving the update accuracy of the positioning and the step size.

### BRIEF DESCRIPTION OF THE DRAWINGS

FIG. 1 is a flowchart of a Bluetooth-based positioning method according to a first embodiment of the present disclosure.

FIG. 2 is a structural diagram of a Bluetooth-based positioning apparatus according to a fifth embodiment of the present disclosure.

### DETAILED DESCRIPTION

A number of technical details are provided herein to help a reader understand the present disclosure in a better manner. However, one of ordinary skill in the art should understand that technical solutions sought to be protected by appended claims of the present disclosure can be implemented without these technical details and based on changes and modifications to the following embodiments.

In order to make the objectives, technical solutions, and advantages of the present disclosure comprehensible, the embodiments of the present disclosure will be further described in detail herein with reference to the accompanying drawings.

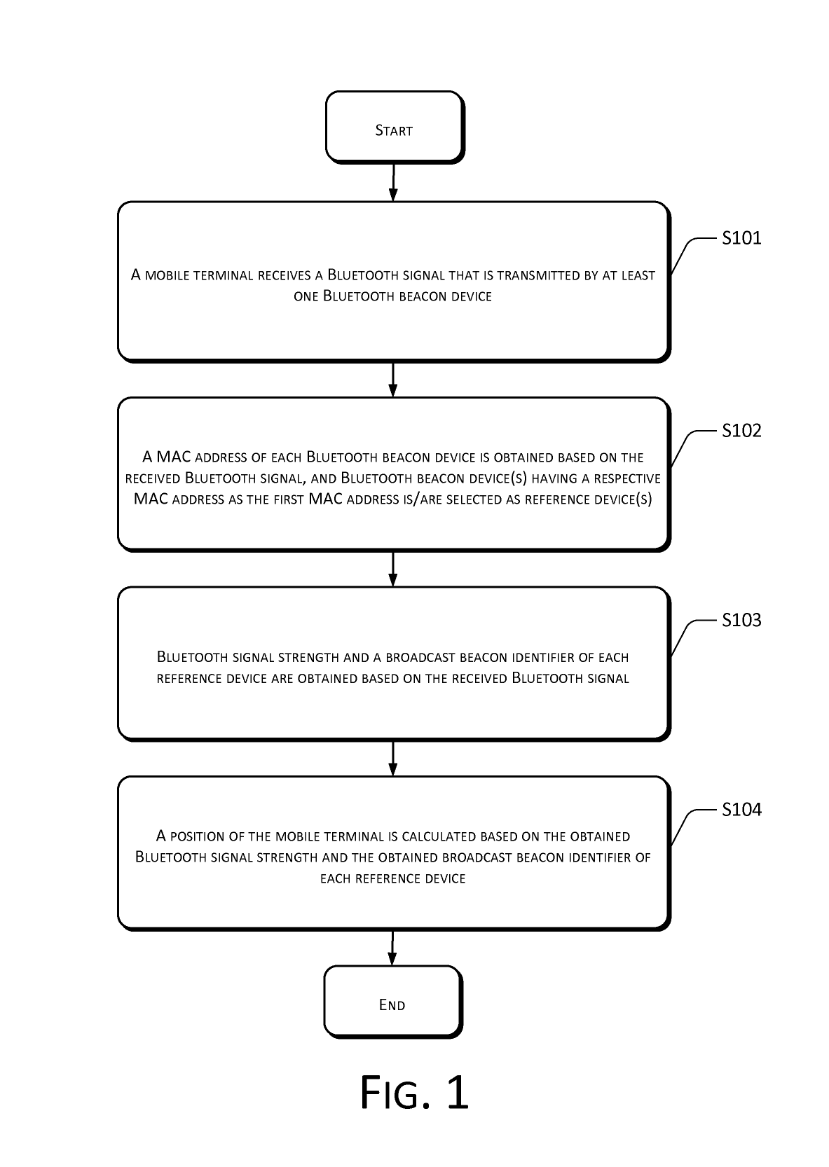

A first embodiment of the present disclosure relates to a Bluetooth-based positioning method. FIG. 1 is a flowchart illustrating the Bluetooth-based positioning method.

In an implementation, at least two Bluetooth beacon devices are arranged in advance in an area where positioning is desired. Media access control (MAC) addresses (i.e., hardware addresses) of the Bluetooth beacon devices are all preset to be a first MAC address, and the Bluetooth beacon devices broadcast different beacon identifiers.

As shown in FIG. 1, the Bluetooth-based positioning method may include:

At S101, a mobile terminal receives a Bluetooth signal that is transmitted by at least one Bluetooth beacon device.

At S102, a MAC address of each Bluetooth beacon device is obtained based on the received Bluetooth signal, and Bluetooth beacon device(s) having a respective MAC address as the first MAC address is/are selected as reference device(s).

At S103, Bluetooth signal strength and a broadcast beacon identifier of each reference device are obtained based on the received Bluetooth signal.

In an implementation, S103 may include a sub-block as follows:

decrypting the received Bluetooth signal to obtain the broadcast beacon identifier of each reference device.

At S104, a position of the mobile terminal is calculated based on the obtained Bluetooth signal strength and the obtained broadcast beacon identifier of each reference device.

As commonly known in existing technologies, each wireless device should have a different MAC address. The present disclosure, however, creatively sets all Bluetooth beacon devices to have a same MAC address. According to the international Bluetooth standard, these Bluetooth beacon devices are regarded as the same device, and MAC addresses of other normal Bluetooth devices are different from the MAC address of these Bluetooth beacon devices. Therefore, interferences from other Bluetooth devices can be effectively eliminated by recognizing the MAC address.

In an implementation, the Bluetooth signal that is transmitted by each Bluetooth beacon device is an encrypted Bluetooth signal that changes over time. S103 may include a sub-block as follows:

decrypting the received Bluetooth signal to obtain the broadcast beacon identifier of each reference device.

In this foregoing implementation, the MAC address may be used in an initial selection of the reference device(s) at S102. Alternatively, the MAC address may not be used at S102, and decryption may be attempted to be performed on the received Bluetooth signal directly. If the decryption is successful, an associated Bluetooth beacon device is used as a reference device. If the decryption fails, the Bluetooth signal is no longer received.

After time-varying encryption and decryption on the Bluetooth signal, a malicious Bluetooth device can be effectively prevented from disguising the same beacon identifier, thereby achieving an accurate positioning.

In addition, it can be understood that many different implementations for S104 exist.

For example, a fingerprint database of Bluetooth signals may be established in advance. The fingerprint database pre-stores a correspondence relationship between Bluetooth fingerprints (with the Bluetooth fingerprints including Bluetooth signal strength and beacon identifiers) and coordinates of positions where the Bluetooth fingerprints are collected. When positioning is needed, a Bluetooth fingerprint received at a current position may be matched with the Bluetooth fingerprints in the Bluetooth fingerprint database, and a position of a mobile terminal may be obtained according to a matching result. For example, Bluetooth fingerprints having a matching degree higher than a threshold (for example, 80%) are selected directly from a Bluetooth fingerprint map, and an average position of positions thereof is calculated and used as the position of the mobile terminal.

In addition, respective positions where Bluetooth beacon devices transmitting signals are arranged may be obtained based on identifiers of the Bluetooth beacon devices. After performing a weight analysis on information of the positions of the devices based on different strength of the Bluetooth signals that are transmitted by the devices, a position of a mobile terminal is obtained, in which the higher the strength of a signal is, the closer a position of a Bluetooth beacon device transmitting the Bluetooth signal to a finally located position will be.

In addition, a particle filtering algorithm may be used to calculate the position. A number of algorithms used in WIFI and geomagnetic positioning methods may also be used in the present disclosure.

A second embodiment of the present disclosure relates to a Bluetooth-based positioning method.

The second embodiment is different from the first embodiment. Major additional features include implementing an accurate positioning of the mobile terminal based on particle filtering, assigning random moving step sizes to particles at an initial stage of positioning, abandoning moving step sizes of particles having a low availability score, and retaining moving step sizes of particles have a high availability score during the positioning, in order to obtain and timely update moving step sizes that are closest to an actual step size of a positioned object during the positioning as a step size of the positioned object changes.

In an implementation, prior to S104, the positioning method may further include:

sampling Bluetooth fingerprints at multiple sampling points in the area where the positioning is desired, and storing the sampled Bluetooth fingerprints and corresponding position information in a Bluetooth fingerprint map in advance; and

at an initial time point of positioning, matching a Bluetooth fingerprint of the Bluetooth signal received by the mobile terminal with Bluetooth fingerprints in the pre-generated Bluetooth fingerprint map, generating an initial particle set according to a matching result, and randomly assigning a different moving step size to each particle in the initial particle set, where a Bluetooth fingerprint includes strength of the received Bluetooth signal and a beacon identifier of a reference device that transmits the Bluetooth signal.

Moreover, S104 may further include the following sub-blocks.

(1) Position information of each particle in a particle set at a previous time point is updated based on a number of moving steps, a moving direction, and a moving step size of each particle that are detected by the mobile terminal at a current time point to obtain a current particle set.

(2) An availability of each particle is scored based on position information of each particle in the current particle set and a Bluetooth fingerprint received at the current time point. A particle of a high score has a high availability, a moving trajectory that is closer to that of an object to be located during the positioning, and a longer persistence.

For example, in an implementation, a score may be determined based on a distance between a particle and a signal fingerprint that is closest to the particle in a signal fingerprint map as well as a strength difference between the signal fingerprint and a currently collected signal fingerprint. In an implementation, a smaller distance between a particle and a signal fingerprint that is closest to the particle in the map and a smaller strength difference between a signal fingerprint collected at the current time point and the signal fingerprint that is closest to the particle in the signal fingerprint map indicate a higher score of the particle. In addition, the scoring may be performed based on a distance between a particle and a signal fingerprint or a strength difference between a closest signal fingerprint and a currently collected signal fingerprint.

(3) An aggregation degree of the particles in the current particle set is calculated based on the scores.

(4) If the aggregation degree of the particles in the current particle set is higher than a first aggregation degree threshold, moving step sizes of particles having scores higher than a first predetermined threshold in the current particle set are obtained, moving step sizes of particles having scores lower than the first predetermined threshold are updated based on the obtained moving step sizes, and the position of the mobile terminal is determined based on the position information of the particles in the current particle set.

The first predetermined threshold may be determined based on a specific scoring method and an application scenario.

A number of approaches may be used for implementation of updating the moving step sizes of the particles having the scores lower than the first predetermined threshold. For example, an average of the moving step sizes of the particles having the scores higher than the first score threshold is calculated, and a random value is added to the average value, which is then assigned to each particle having a score lower than the first score threshold. Additionally or alternatively, a median or a weighted average of the moving step sizes of the particles having the scores higher than the first score threshold may be calculated and assigned to each particle having a score lower than the first score threshold. A random value may be added to the average value, the median or the weighted average. Alternatively, a random value may not be added, and the average value, the median or the weighted average may be directly used as a moving step size for each particle having a score lower than the first score threshold.

A number of approaches may be used for implementation of determining the position of the mobile terminal based on the position information of the particles in the current particle set. For example, an average position of all the particles in the current particle set is calculated and used as the position of the mobile terminal. Alternatively, multiple particles of high availability scores are selected, and an average position of the selected particles is calculated and used as the position of the mobile terminal, etc.

It may be understood that, in other implementations, a positioning result may be determined at a frequency different from that of updates of moving step sizes of particles. For example, a position of a mobile terminal may be determined based on position information of particles in a current particle set at a particular period different from that of step size update. Alternatively, a positioning result of the mobile terminal may be outputted in response to an instruction of a user.

A number of methods for processing particles in the current particle set having scores equal to the first predetermined threshold exist. For example, the particles may be used together with the high-score particles (i.e., the particles having the scores higher than the first predetermined threshold) for updating the moving step sizes of the low-score particles (i.e., the particles having the scores lower than the first predetermined threshold), or may be treated as update objects together with the low-score particles with moving step sizes thereof being updated based on the high-score particles, or may neither be treated to update moving step sizes thereof nor be used as a basis for updating moving step sizes of other particles.

(5) If the aggregation degree of the particles in the current particle set is lower than the first aggregation degree threshold, this indicates that the aggregation degree of the scores of the particles in the current particle set is low. The positioning fails, and the method blocks of collecting particles for generating an initial particle set is performed again.

When an aggregation degree of scores of particles in a current particle set is calculated, if the particle score aggregation degree is low, this indicates that the positioning fails. Generation of an initial particle set needs to be re-initiated, moving step sizes are updated, and the mobile terminal is then located, in order to avoid unnecessary computation and improve positioning efficiency.

In addition, sub-block (2) of scoring the availability of each particle based on the position information of each particle in the current particle set and the Bluetooth fingerprint received at the current time point may include the following sub-blocks:

obtaining position information and signal strength of a Bluetooth fingerprint that is closest to a respective particle in the Bluetooth fingerprint map; and

scoring the availability of the respective particle based on the Bluetooth fingerprint collected at the current time point, the obtained position information and the obtained signal strength. For example, a smaller distance between a particle and a Bluetooth fingerprint closest to the particle in the map and a smaller strength difference between a Bluetooth fingerprint collected at the current time point and the Bluetooth fingerprint that is closest to the particle in the Bluetooth fingerprint map indicate a higher score of the particle.

In an implementation, the entire Bluetooth fingerprint map is rasterized, and a correspondence relationship between each grid and an identifier of a Bluetooth fingerprint that is closest to each grid is stored in advance. Moreover, the foregoing sub-block of obtaining the position information and the signal strength of the Bluetooth fingerprint that is closest to the particle in the Bluetooth fingerprint map may be implemented by the following approach:

searching for an identifier of a Bluetooth fingerprint that is closest to a grid at which the particle is located in the Bluetooth fingerprint map based on the correspondence relationship, and obtaining position information and a signal strength of the Bluetooth fingerprint that is closest to the particle based on an identifier that is found.

Rasterization search is performed, so that a comparison of each particle with all signal fingerprints in a fingerprint map is not needed, thus greatly reducing computation workload and improve positioning efficiency.

In addition, it is understood that each particle in the present disclosure may be an object or a data structure, which may include information, such as a position, a direction and a step size, etc., of a mobile terminal, and indicates a possibility of the information such as the position, the direction and the step size of the mobile terminal.

A third embodiment of the present disclosure relates to a Bluetooth-based positioning method.

The third embodiment is different from the second embodiment, and a main additional feature is that, when an aggregation degree of scores of particles in a current particle set is low and a failure in positioning is not resulted yet, the current particle set may be updated, particles having a low score may be deleted, and new particles may be generated based on particles having a high score, in order to improve the aggregation degree of the scores associated with the entire current particle set, thereby improving the accuracy of positioning and step size update.

In an implementation, prior to sub-block (4), S104 may further include the following sub-blocks:

determining whether the aggregation degree of the particles in the current particle set is lower than a second aggregation degree threshold, where the second aggregation degree threshold is greater than the first aggregation degree threshold;

deleting particles having a respective score lower than a second score threshold from the current particle set in response to a determination result being affirmative;

generating particles having a score higher than the second score threshold as many as the deleted particles to form an updated current particle set based on position information of particles in the current particle set that remain after deletion; and

determining the position of the mobile terminal based on positions of particles in the updated current particle set and performing sub-block (4).

In addition, it is understood that the second score threshold may be the same as the first score threshold or may be different from the first score threshold.

A fourth embodiment of the present disclosure relates to a Bluetooth-based positioning method. In an implementation, the method may include:

(1) Fingerprint Map Generation

At least two of the foregoing Bluetooth beacon devices are arranged in advance in an area where positioning is needed. A Bluetooth fingerprint map is then generated using a point sampling method or a straight line method.

a) Point Sampling Method:

A mobile terminal is taken to a position in an area where positioning is needed. A current position is set in the mobile terminal, and a Bluetooth fingerprint at the current position <ID₁: RSSI₁, ID₂: RSSI₂, . . . , IDₙ: RSSIₙ, . . . , Position> is collected. Bluetooth fingerprints at multiple positions are recorded to form a Bluetooth fingerprint map, where IDₙ is an identifier of an n^{th} Bluetooth beacon device that transmits a Bluetooth signal at a certain current position, RSSIₙ indicates a strength of the Bluetooth signal transmitted by the Bluetooth beacon device, and Position is position information of the current position.

b) Straight Line Method:

A mobile terminal is taken to a certain position in an area where positioning is needed. A current position is set in the mobile terminal. Walk a distance along a straight line at a constant speed, stop, and set a stop position in the mobile terminal (such as a mobile phone). During the walk, the mobile terminal records Bluetooth fingerprints at an average interval and assigns an actual position to each fingerprint by means of difference value. The Bluetooth fingerprints that are collected in the entire process are recorded. A designated fingerprint map synthesis software is used to form a whole Bluetooth fingerprint map using all the data, where the software may select to delete or move certain fingerprint points.

(2) Particle Filtering Integrated Navigation

Particle filtering refers to an process of approximating a probability density function by finding a set of random samples propagated in a state space, using a sample mean to replace an integral operation and obtaining an estimate of the minimum variance of a system state, where the samples are vividly referred to as “particles” and thus the process is called particle filtering. A probability distribution of particles in particle filtering is a real approximation, and the particle filtering has a better adaptability to non-linear and non-Gaussian systems as compared with Kalman filtering.

In this implementation, the particle filtering integrated navigation may include the following procedure:

a) Particle initialization, i.e., decrypting a Bluetooth fingerprint that is received by a mobile terminal, matching the Bluetooth fingerprint with Bluetooth fingerprints in a pre-generated Bluetooth fingerprint map, generating an initial particle set according to a matching result, and randomly assigning a different moving step size to each particle in the initial particle set. In an embodiment, an exemplary implementation may include the following:

Global fingerprint matching is used. In other words, a current Bluetooth fingerprint is compared with Bluetooth fingerprints in a Bluetooth fingerprint map, and a score thereof is:

$$S = {\sum }_{i = 1}^{m} {( \vec{r} - {\vec{r}}_{n}^{′} )}^{2}$$

where \vec{r} is a strength vector (which includes a strength of a Bluetooth signal and an identifier of a Bluetooth beacon device that transmits the Bluetooth signal) of a real-time Bluetooth fingerprint, \vec{r}′ₙ is a strength vector of a Bluetooth fingerprint in the Bluetooth fingerprint database, and m is a number of Bluetooth fingerprints that are matched. The top P % of Bluetooth fingerprints are then selected according to the score S, and a lower matching score of a Bluetooth fingerprint indicates a higher probability of generating a particle. Each particle has the following attributes:

X₁=X₀+Gauss(0,dₓ),

Y₁=Y₀+Gauss(0,d_{y}),

zero_angle=random(0,360),

step_size=step_size×(1+random(−dₛ,dₛ)),

where X₁ is an x-coordinate of a respective particle at an initial position, Y₁ is a y-coordinate of the respective particle at the initial position; zero_angle is a current zero declination angle of a magnetic sensor; step_size is a moving step size of the respective particle; X₀ and Y₀ are a horizontal coordinate and a vertical coordinate of a position of a corresponding matched Bluetooth fingerprint in the fingerprint database; Gauss is a Gaussian function, in which the first parameter 0 is a mean, and the second parameter dₓ or d_{y} is a variance; random is a random function, in which the first parameter is a lower limit, and the second parameter is an upper limit; dₓ and d_{y} are respective variances of displacements x and y, and dₛ is a random ratio coefficient of the step size.

b) Particle update, i.e., updating position information of each particle in a particle set at a previous time point based on a number of moving steps, a moving direction, and a moving step size of each particle that are detected by a mobile terminal at a current time point to obtain a current particle set. In an embodiment of the present disclosure, an exemplary implementation is given as follows.

An acceleration sensor and a magnetic sensor of the mobile terminal may detect a step number difference and a moving direction. Equations of position information of a particle after a n^{th} update are given as follows:

Xₙ₊₁=Xₙ+(cos(θₙ+zero_angleₙ)+Gauss(0,Dₑₓ))*step_size*Δstep_num+Gauss(0,Dₐₓ)

Yₙ₊₁=Yₙ+(sin(angleₙ+zero_angleₙ)+Gauss(0,D_{ey}))*step_size*Δstep_num+Gauss(0,D_{ay})

zero_angleₙ₊₁=zero_angleₙ+(angleₙ−angleₙ₋₁)*Gauss(0,Aₑ)+Gauss(0,D_{ay})

where Xₙ represents a horizontal coordinate of the particle after a (n−1)^{th} update, Yₙ represents a vertical coordinate of the particle after the (n−1)^{th} update, step_size represents a moving step size of the particle, zero_angleₙ represents a magnetic declination angle of the particle after the (n−1)^{th} update, angleₙ represents an absolute degree of the magnetic sensor at a current time point, angleₙ₋₁ represents an absolute degree of the magnetic sensor at the (n−1)^{th} update of the particle, Dₑₓ represents a static deviation of a horizontal coordinate of a displacement, Dₐₓ represents a random deviation of a vertical coordinate of the displacement, D_{ey} represents a static deviation of a vertical coordinate of the displacement, D_{ay} represents a random deviation of the vertical coordinate of the displacement, Aₑ represents a static deviation of a zero position angle, Aₐ represents a random deviation of the zero position angle, and Gauss is a Gaussian function, in which the first parameter is a mean, and the second parameter is a variance.

Furthermore, the strength of the Bluetooth signal received by the mobile terminal at the current time point is treated as a current Bluetooth signal strength of the particle. In other words, a currently detected Bluetooth fingerprint is assigned to a Bluetooth fingerprint corresponding to the particle.

c) Particle scoring, i.e., assigning a score for an availability of each particle based on position information of the respective particle in a current particle set and a signal fingerprint received at a current time point.

In an implementation, score assignment for particles may be implemented using the following approach:

A score is assigned to each particle after the particles are updated. If a Bluetooth fingerprint that is at the closest Euclidean distance from a particle P(Xₚ_{ₙ}, Yₚ_{ₙ}, \vec{F}ₚ_{ₙ}) at a current time point is F(X_{f}_{ₙ}, Y_{f}_{ₙ}, \vec{F}_{f}_{ₙ}) in a Bluetooth fingerprint map, a score W of the particle is:

W=1/e^{D/K}^{₁}^{²}*(1/e^{R}^{²}^{/K}^{₂}^{²})

where D=|\vec{F}ₚ_{ₙ}−\vec{F}_{f}_{ₙ}|, R={square root over (((Xₚ_{ₙ}−X_{f}_{ₙ})²+(Yₚ_{ₙ}−Y_{f}_{ₙ})²))}, \vec{F}ₚ_{ₙ} represents a strength vector of a Bluetooth fingerprint corresponding to the particle P(Xₚ_{ₙ}, Yₚ_{ₙ}, \vec{F}ₚ_{ₙ}) at the current time point, i.e., a Bluetooth fingerprint (which includes each Bluetooth signal and a respective identifier associated with each Bluetooth signal that is transmitted) that is collected at the current time point, \vec{F}_{f}_{ₙ} represents a Bluetooth fingerprint strength vector of the Bluetooth fingerprint F(X_{f}_{ₙ}, Y_{f}_{ₙ}, \vec{F}_{f}_{ₙ}), Xₚ_{ₙ} and Yₚ_{ₙ} represent a horizontal coordinate and a vertical coordinate of the particle P(Xₚ_{ₙ}, Yₚ_{ₙ}, \vec{F}ₚ_{ₙ}) at the current time point respectively, X_{f}_{ₙ} and Y_{f}_{ₙ} represent a horizontal coordinate and a vertical coordinate of the Bluetooth fingerprint F(X_{f}_{ₙ}, Y_{f}_{ₙ}, \vec{F}_{f}_{ₙ}) respectively, and K₁ and K₂ represent corresponding fixed parameters.

In another implementation, score assignment for particles may be implemented using the following approach:

A score is assigned using a relative value, i.e., scoring is performed using a relative variation of a fingerprint. For example, for a particle, the strength of Bluetooth signals transmitted by Bluetooth beacon devices having a same identifier that are currently at the closest Euclidean distance from the particle in a Bluetooth fingerprint is −90 dB and the strength is −80 dB at the next time point. For a Bluetooth fingerprint received by a mobile device, the strength of Bluetooth signals currently transmitted by Bluetooth beacon devices having a same identifier is −80, and the strength is −70 dB at the next time point. Although absolute values of the strength of the Bluetooth fingerprints are different at the same time point, relative difference values at the two time points are both 10 dB. In this case, a degree of matching between the Bluetooth fingerprints is counted as a full score. Apparently, scores in terms of fingerprint distance do not change. An advantage of this type of scoring is to address a problem of inconsistency of RSSIs that are scanned by different mobile devices for a same Bluetooth beacon. If a Bluetooth fingerprint that is at the closest Euclidean distance from a particle P(Xₚ_{ₙ}, Yₚ_{ₙ}, \vec{F}ₚ_{ₙ}) at a current time point is F(X_{f}_{ₙ}, Y_{f}_{ₙ}, \vec{F}_{f}_{ₙ}) in a Bluetooth fingerprint map, a score W of the particle is:

W=1/e^{D/K}^{₁}^{²}*(1/e^{R}^{²}^{/K}^{₂}^{²})

where D=|ΔFₚ_{ₙ}−ΔF_{f}_{ₙ}|, R={square root over (((Xₚ_{ₙ}−X_{f}_{ₙ})²+(Yₚ_{ₙ}−Y_{f}_{ₙ})²))}, ΔFₚ_{ₙ}=Fₚ_{ₙ}−Fₚ_{_{n−1}}, ΔF_{f}_{ₙ}=F_{f}_{ₙ}−F_{f}_{_{n−1}}, \vec{F}ₚ_{ₙ} represents a strength vector of a Bluetooth fingerprint corresponding to the particle \vec{F}ₚ_{ₙ} at the current time point, i.e., a Bluetooth fingerprint (which includes each Bluetooth signal and an identifier associated with each Bluetooth signal that is transmitted) that is collected at the current time point, \vec{F}_{f}_{ₙ} represents a Bluetooth fingerprint strength vector of the Bluetooth fingerprint F(X_{f}_{ₙ}, Y_{f}_{ₙ}, \vec{F}_{f}_{ₙ}), Xₚ_{ₙ} and Yₚ_{ₙ} represent a horizontal coordinate and a vertical coordinate of the particle P(Xₚ_{ₙ}, Yₚ_{ₙ}, \vec{F}ₚ_{ₙ}) at the current time point respectively, X_{f}_{ₙ} and Y_{f}_{ₙ} represent a horizontal coordinate and a vertical coordinate of the Bluetooth fingerprint F(X_{f}_{ₙ}, Y_{f}_{ₙ}, \vec{F}_{f}_{ₙ}) respectively, Fₚ_{_{n−1}} indicates a strength vector of a Bluetooth fingerprint corresponding to the particle P(Xₚ_{ₙ}, Yₚ_{ₙ}, \vec{F}ₚ_{ₙ}) at a previous time point, F_{f}_{_{n−1}} represents a strength vector of a Bluetooth fingerprint that is at the closest Euclidean distance from the particle at the previous time point, and K₁ and K₂ represent corresponding fixed parameters.

d) Particle resampling, i.e., deleting particles in a current particle set having a respective score lower than a second score threshold in response to a score aggregation degree of the current particle set being lower than a second aggregation degree threshold and higher than a first aggregation degree threshold; and generating particles having a respective score higher than the second score threshold as many as a number of particles that have been deleted to form an updated current particle set based on position information of particles that remain in the current particle set after deletion.

In an embodiment, an exemplary implementation for particle resampling is given as follows:

An aggregation degree G of particles is represented as:

G=Wₐₗₗ²/W_{cor}/m

where Wₐₗₗ is a sum of scores of all particles at a current time point, i.e., Wₐₗₗ=Σᵢ₌₁^{m}Wᵢ, W_{cor} is a sum of squares of the scores of all the particles at the current time point, i.e., W_{cor}=Σᵢ₌₁^{m}Wᵢ², and m is a total number of the particles in the current particle set.

When T₁<G<T₂, an operation of particle resampling is performed, particles having a score lower than the second score threshold are deleted. A same number of new particles are generated, and particles having a higher weight among the remaining particles are undergone particle resampling at a higher probability, so that a total number of the particles does not change, where T₁ is the first aggregation degree threshold and T₂ is the second aggregation degree threshold.

Moving step sizes of particles in the current particle set that have respective scores lower than a first score threshold after resampling are then updated based on moving step sizes of particles having respective scores higher than the first score threshold in the current particle set after resampling.

When the weight G is low, i.e., when G<T₁, the positioning is considered to have failed, and particle initialization needs to be performed again.

During the resampling, the particles are changed and displaced with certain probability and magnitude, i.e., zero_angle and step_size.

Moreover, a final positioning result, i.e., a result of weighted averaging of position information of all particles having a score higher than a third score threshold, may be outputted.

In embodiments of the present disclosure, assigning scores of particles in a particle set and calculation of an aggregation degree thereof may be performed using other equations.

The method embodiments of the present disclosure may be implemented in a form of software, hardware, firmware, etc. No matter Regardless of whether the disclosed method is implemented using software, hardware or firmware, an instruction code may be stored in any type of computer-accessible storage device (e.g., permanent or modifiable, volatile or non-volatile, solid-state or non-solid-state, fixed or removable media, etc.). Also, the storage device may be, for example, a programmable array logic (PAL), a random access memory (RAM), a programmable read only memory (PROM), a read-only memory (ROM), an electrically erasable programmable ROM (EEPROM), a magnetic disk, an optical disc, a digital versatile disc (DVD), etc.

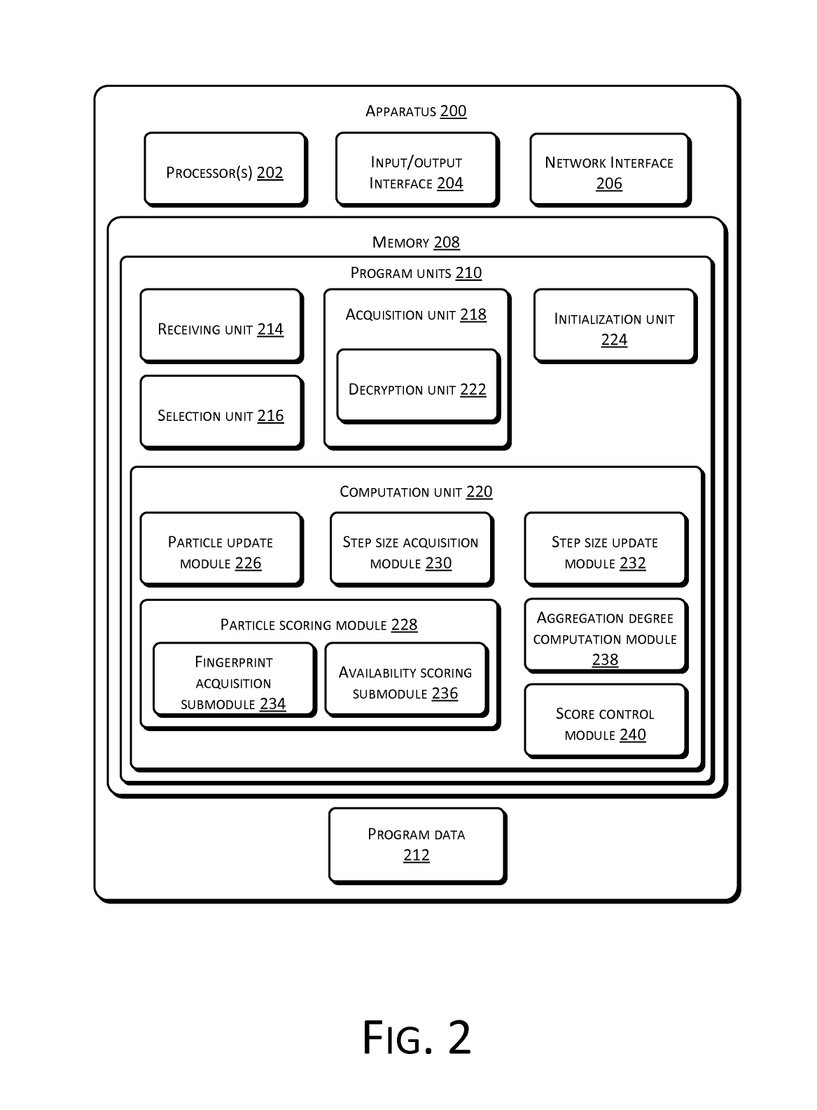

A fifth embodiment of the present disclosure is related to a Bluetooth-based positioning apparatus. FIG. 2 shows a structural diagram of a Bluetooth-based positioning apparatus 200.

In an implementation, at least two Bluetooth beacon devices are arranged in advance in an area where positioning is needed. MAC addresses of the Bluetooth beacon devices are all a preset first MAC address, and the Bluetooth beacon devices broadcast different beacon identifiers. As shown in FIG. 2, the Bluetooth-based positioning apparatus 200 may include one or more processors 202, an input/output (I/O) interface 204, a network interface 206 and memory 208.

The memory 208 may include a form of computer readable media such as volatile memory, Random Access Memory (RAM), and/or non-volatile memory, e.g., Read-Only Memory (ROM) or flash RAM, etc. The memory 208 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In an implementation, the memory 208 may include program units 210 and program data 212. The program units 210 may include a receiving unit 214 configured to control a mobile terminal to receive a Bluetooth signal transmitted by at least one Bluetooth beacon device; a selection unit 216 configured to obtain a MAC address of each Bluetooth beacon device based on the received Bluetooth signal and select Bluetooth beacon device(s) having a MAC address as the first MAC address to be reference device(s); an acquisition unit 218 configured to obtain a Bluetooth signal strength and a broadcast beacon identifier of each reference device based on the received Bluetooth signal; and a computation unit 220 configured to calculate a position of the mobile terminal based on the obtained Bluetooth signal strength and the obtained broadcast beacon identifier of each reference device.

In an implementation, the Bluetooth signal transmitted by each Bluetooth beacon device is a time-varying encrypted Bluetooth signal. Moreover, the acquisition unit 218 may include a decryption module 222 configured to decrypt the received Bluetooth signal to obtain the broadcast beacon identifier of each reference device.

The first embodiment is a method embodiment corresponding to the present embodiment. The present embodiment and the first embodiment can collaborate with each other for implementations. Related technical details described in the first embodiment are still operative in the present embodiment, which are not repeatedly described herein. Correspondingly, relevant technical details described in the present embodiment can also be applied in the first embodiment.

A sixth embodiment of the present disclosure is related to a Bluetooth-based positioning apparatus.

The sixth embodiment is developed from the fifth embodiment. Major additional features include implementing an accurate positioning of the mobile terminal based on particle filtering, assigning random moving step sizes to particles at an initial stage of positioning, abandoning moving step sizes of particles having a low availability score, and retaining moving step sizes of particles have a high availability score during the positioning, in order to obtain and timely update moving step sizes that are closest to an actual step size of a positioned object during the positioning as a step size of the positioned object changes.

In an implementation, the positioning apparatus 200 may further include an initialization unit 224 configured to match a Bluetooth fingerprint of the Bluetooth signal received by the mobile terminal with Bluetooth fingerprints in a pre-generated Bluetooth fingerprint map, generate an initial particle set according to a matching result, and randomly assign a different moving step size to each particle in the initial particle set at an initial time point of positioning before the computation unit 220 calculates the position of the mobile terminal, where the Bluetooth fingerprint includes a strength of the received Bluetooth signal and a beacon identifier of a reference device that transmits the Bluetooth signal.

Moreover, the computation unit 200 may include a particle update module 226 configured to update position information of each particle in a particle set at a previous time point based on a number of moving steps, a moving direction, and a moving step size of each particle that are detected by the mobile terminal at a current time point to obtain a current particle set; a particle scoring module 228 configured to score an availability of each particle according to position information of each particle in the current particle set and a Bluetooth fingerprint received at the current time point; a step size acquisition module 230 configured to obtain moving step size(s) of particle(s) having a score higher than a first predetermined threshold from the current particle set; and a step size update module 232 configured to update moving step size(s) of particle(s) having a score lower than the first predetermined threshold based on the obtained moving step size(s).

In addition, the particle scoring module 228 may include a fingerprint acquisition submodule 234 configured to obtain position information and signal strength of a Bluetooth fingerprint that is closest to the particle in the Bluetooth fingerprint map; and an availability scoring submodule 236 configured to score the availability of the particle based on the Bluetooth fingerprint collected at the current time point and the obtained position information and signal strength.

In an implementation, the entire Bluetooth fingerprint map is rasterized, and a correspondence relationship between each grid and an identifier of a Bluetooth fingerprint that is closest to the respective grid is stored in advance. Moreover, the function of the fingerprint acquisition submodule 234 may be implemented by finding an identifier of a Bluetooth fingerprint that is closest to a grid where the particle is located from the Bluetooth fingerprint map based on the correspondence relationship, and obtaining the position information and the signal strength of the Bluetooth fingerprint that is closest to the particle based on the found identifier.

In implementation, the computation unit 200 may further include an aggregation degree computation module 238 configured to calculate an aggregation degree of the particles in the current particle set according to the scores of the particles in the current particle set obtained from the particle scoring module 228; and a score control module 240 configured to control the step size acquisition module 230 to obtain the moving step sizes of the particles in the current particle set having the score higher than the first score threshold in response to the aggregation degree of the particles in the current particle set being higher than a first aggregation degree threshold.

The second embodiment is the method embodiment corresponding to the present embodiment. The present embodiment and the second embodiment can collaborate with each other for implementations. Related technical details described in the second embodiment are still operative in the present embodiment, which re not repeatedly described herein. Correspondingly, related technical details described in the present embodiment can also be applied in the second embodiment.

It should be noted that all the units mentioned in the apparatus embodiments of the present disclosure are logical units. Physically, a logical unit may be a physical unit or a part of the physical unit, or may be implemented through a combination of multiple physical units. The physical implementation of these logical units is not the most important. Rather, the combination of functions implemented by these logical units is the key to solving the technical problem set forth in the present disclosure. In addition, in order to highlight the innovative portions of the present disclosure, units that are not closely related to the technical problem set forth in the present disclosure are not introduced in the foregoing apparatus embodiments of the present disclosure, which, however, does not indicate that other units do not exist in the foregoing apparatus embodiments.

It should be noted that relational terms such as “first” and “second”, etc., in appended claims and specification for the present patent application are merely used to distinguish one entity or operation from another entity or operation without necessarily requiring or implying any such type of actual relationship or order between these entities or operations. Moreover, terms such as “comprise”, “include” or any other variations thereof are meant to cover the non-exclusive inclusions. The process, method, product or apparatus that includes a series of elements not only includes those elements, but also includes other elements that are not explicitly listed, or further includes elements that already existed in such process, method, product or apparatus. In a condition without further limitations, an element defined by the phrase “include a/an . . . ” does not exclude any other similar elements from existing in the process, method, product or apparatus.

Although the present disclosure has been shown and described using certain exemplary embodiments of the present disclosure, one skilled in the art should understand that different types of changes in forms and details can be made without departing from the spirit and scope of the present disclosure.

What is claimed is:

1. A method implemented by a computing device, the method comprising:
receiving a signal transmitted by one or more beacon devices of a plurality of beacon devices, the plurality of beacon devices sharing a same first media access control (MAC) address and broadcasting different beacon identifiers;
obtaining a MAC address of each beacon device of the one or more beacon devices based at least in part on the received signal;
selecting at least one beacon device having a respective MAC address as the first MAC address to be at least one reference device;
obtaining a signal strength and a broadcast beacon identifier of each reference device of the at least one reference device based at least in part on the received signal; and
calculating a position of the computing device based at least in part on the obtained signal strength and the obtained broadcast beacon identifier of each reference device.

2. The method of claim 1, wherein the signal transmitted by each beacon device comprises an encrypted signal that varies over time.

3. The method of claim 2, wherein obtaining the signal strength and the broadcast beacon identifier of each reference device comprises decrypting the received signal to obtain the broadcast beacon identifier of each reference device.

4. The method of claim 1, further comprising:
matching a fingerprint of the signal received by the computing device with fingerprints in a pre-generated fingerprint map;
generating an initial particle set according to a matching result; and
randomly assigning a different moving step size to each particle in the initial particle set.

5. The method of claim 4, wherein calculating the position of the computing device comprises:
updating position information of each particle in a previous particle set at a previous time point based at least in part on a number of moving steps, a moving direction, and a moving step size of each particle that are detected by the computing device at a current time point to obtain a current particle set;
scoring an availability of each particle based at least in part on position information of each particle in the current particle set and a particular fingerprint received at the current time point;
obtaining one or more moving step sizes of one or more particles having a respective score higher than a first predetermined threshold from the current particle set; and
updating at least one moving step size of at least one particle having a respective score lower than the first predetermined threshold based at least in part on the one or more obtained moving step sizes.

6. The method of claim 5, wherein scoring the availability of each particle comprises:
obtaining respective position information and a respective signal strength of a fingerprint that is closest to each particle in the fingerprint map; and
scoring the availability of each particle based at least in part on the particular fingerprint collected at the current time point and the respective position information and the respective signal strength of the fingerprint that is closest to each particle in the fingerprint map.

7. The method of claim 6, wherein the pre-generated fingerprint map is rasterized, and a correspondence relationship between each grid and an identifier of a respective fingerprint that is closest to each grid is stored in advance.

8. The method of claim 7, wherein obtaining the respective position information and the respective signal strength of the fingerprint that is closest to each particle in the fingerprint map comprises:
finding an identifier of a fingerprint that is closest to a grid where each particle is located in the fingerprint map based at least in part on the correspondence relationship; and
obtaining the respective position information and the respective signal strength of the fingerprint that is closest to each particle based at least in part on the found identifier.

9. The method of claim 5, wherein: prior to obtaining the one or more moving step sizes of the one or more particles having the respective score higher than the first predetermined threshold from the current particle set, calculating the position of the computing device comprises:
calculating an aggregation degree of particles in the current particle set based at least in part on scores of the particles of the current particle set; and
obtaining the one or more moving step sizes of the one or more particles having the respective score higher than the first predetermined threshold from the current particle set in response to the aggregation degree of the particles in the current particle set being higher than a first aggregation degree threshold.

10. An apparatus comprising:
one or more processors;
memory;
a receiving unit stored in the memory and executable by the one or more processors to control the apparatus to receive a signal transmitted by one or more beacon devices of a plurality of beacon devices, wherein the plurality of beacon devices share a same first media access control (MAC) address and broadcast different beacon identifiers;
a selection unit stored in the memory and executable by the one or more processors to obtain a MAC address of each beacon device of the one or more beacon devices based at least in part on the received signal, and select at least one beacon device having a respective MAC address as the first MAC address to be at least one reference device;
an acquisition unit stored in the memory and executable by the one or more processors to obtain a signal strength and a broadcast beacon identifier of each reference device of the at least one reference device based at least in part on the received signal; and
a computation unit stored in the memory and executable by the one or more processors to calculate a position of the apparatus based at least in part on the obtained signal strength and the obtained broadcast beacon identifier of each reference device.

11. The apparatus of claim 10, wherein the signal transmitted by each beacon device comprises a time-varying encrypted signal, and wherein the acquisition unit comprises a decryption module configured to decrypt the received signal to obtain the broadcast beacon identifier of each reference device.

12. The apparatus of claim 10, further comprising an initialization unit to match a fingerprint of the signal received by the apparatus with fingerprints in a pre-generated fingerprint map, generate an initial particle set according to a matching result, and randomly assign a different moving step size to each particle in the initial particle set before the calculation unit calculates the position of the apparatus.

13. The apparatus of claim 12, wherein the calculation unit comprises:
a particle update module configured to update position information of each particle in a previous particle set at a previous time point based at least in part on a number of moving steps, a moving direction, and a moving step size of each particle that are detected by the apparatus at a current time point to obtain a current particle set;
a particle scoring module configured to score an availability of each particle based at least in part on position information of each particle in the current particle set and a particular fingerprint received at the current time point;
a step size acquisition module configured to obtain one or more moving step sizes of one or more particles having a respective score higher than a first predetermined threshold from the current particle set; and
a step size update module configured to update at least one moving step size of at least one particle having a respective score lower than the first predetermined threshold based at least in part on the one or more obtained moving step sizes.

14. The apparatus of claim 13, wherein the particle scoring module comprises:
a fingerprint acquisition submodule configured to obtain respective position information and a respective signal strength of a fingerprint that is closest to the particle in the fingerprint map; and
an availability scoring submodule configured to score the availability of each particle based at least in part on the particular fingerprint collected at the current time point and the respective position information and the respective signal strength of the fingerprint that is closest to each particle in the fingerprint map.

15. The apparatus of claim 14, wherein the pre-generated fingerprint map is rasterized, and a correspondence relationship between each grid and an identifier of a respective fingerprint that is closest to each grid is stored in advance.

16. The apparatus of claim 15, wherein the fingerprint acquisition submodule finds an identifier of a fingerprint that is closest to a grid where each particle is located in the fingerprint map based at least in part on the correspondence relationship, and obtains the respective position information and the respective signal strength of the fingerprint that is closest to each particle based at least in part on the found identifier.

17. The apparatus of claim 13, wherein the computation unit further comprises:
an aggregation degree computation module configured to calculate an aggregation degree of particles in the current particle set based at least in part on scores of the particles of the current particle set obtained by the particle scoring module; and
a score control module configured to obtain the one or more moving step sizes of the one or more particles having the respective score higher than the first predetermined threshold from the current particle set in response to the aggregation degree of the particles in the current particle set being higher than a first aggregation degree threshold.

18. One or more computer-readable media storing executable instructions that, when executed by a computing device, cause the computing device to perform acts comprising:
receiving a signal transmitted by one or more beacon devices of a plurality of beacon devices, the plurality of beacon devices sharing a same first media access control (MAC) address and broadcasting different beacon identifiers;
obtaining a MAC address of each beacon device of the one or more beacon devices based at least in part on the received signal;
selecting at least one beacon device having a respective MAC address as the first MAC address to be at least one reference device;
obtaining a signal strength and a broadcast beacon identifier of each reference device of the at least one reference device based at least in part on the received signal; and
calculating a position of the computing device based at least in part on the obtained signal strength and the obtained broadcast beacon identifier of each reference device.

19. The one or more computer-readable media of claim 18, the acts further comprising:
matching a fingerprint of the signal received by the computing device with fingerprints in a pre-generated fingerprint map;
generating an initial particle set according to a matching result; and
randomly assigning a different moving step size to each particle in the initial particle set.

20. The one or more computer-readable media of claim 19, wherein calculating the position of the computing device comprises:
updating position information of each particle in a previous particle set at a previous time point based at least in part on a number of moving steps, a moving direction, and a moving step size of each particle that are detected by the computing device at a current time point to obtain a current particle set;
scoring an availability of each particle based at least in part on position information of each particle in the current particle set and a particular fingerprint received at the current time point;
obtaining one or more moving step sizes of one or more particles having a respective score higher than a first predetermined threshold from the current particle set; and
updating at least one moving step size of at least one particle having a respective score lower than the first predetermined threshold based at least in part on the one or more obtained moving step sizes.
